(19) United States
(12) Patent Application Publication
(10) Pub. No.: US 2011/0094609 A1
(43) Pub. Date: Apr. 28, 2011

(54) Molded Flow Control Components With Traceable Indicia

(76) Inventor: Richard Schroder, Lebanon, OH (US)

(21) Appl. No.: 12/764,079

(22) Filed: Apr. 20, 2010

Related U.S. Application Data
(60) Provisional application No. 61/170,925, filed on Apr. 20, 2009.

(51) Int. Cl. F15D 1/00

(52) U.S. Cl. 137/560

(57) ABSTRACT

A valve diaphragm is provided with indicia of origin, batch number, date of manufacture and other information. Critical indicia are disposed on outwardly projecting tabs that can be see when the diaphragm is operatively mounted in the valve. Indicia may be provided on elastomeric and non-elastomeric portions of the diaphragm.

### CROSS TO REFERENCE TO RELATED APPLICATION

The present U.S. Non-Provisional Patent Application is related to U.S. Provisional Application for Patent No. 61/170,925 filed Apr. 20, 2009 and entitled “Molded Flow Control Components With Traceable Indicia”, and is incorporated herein by reference in its entirety.

### BACKGROUND OF THE INVENTION

1. Field of the Invention

The present marking system relates to flow control equipment and more particularly to the marking of valve diaphragms and other molded components used to contain and control the flow of process fluids in the sanitary product industry. These components are typically used in the production of pharmaceutical, food and dairy products

2. Related Art

Quality control in the pharmaceutical, food and dairy industries requires specialized and thorough tracing of all materials and process components used in manufacture (traceability). This traceability requirement extends to the production apparatus and includes both original equipment and replacement parts. To ensure consumer safety, it is important to have complete records of the composition of all components that come into contact with the food, dairy, and pharmaceutical process streams and to be able to trace or determine when and where each of these components were made. Food, dairy and pharmaceutical ingredients flow through a multiplicity of valves during a process run. Typically, the valves are provided with diaphragms that come into direct contact with the ingredients in the process stream. The diaphragms are subject to wear and are replaced at scheduled intervals. In the past, data sheets indicating date and location of manufacture, batch number, composition and other particulars have been packaged with the valve diaphragms. However, these data sheets usually become separated from the diaphragms when the diaphragms are installed in the valves. Although records of each diaphragm and its location in the complex piping system are normally kept, during installation, parts of differing origins and materials sometimes may inadvertently become mixed together and traceability is lost in the process. During periodic quality control reviews or inspections, it can be difficult to connect a particular diaphragm with its data sheet even if time and effort has been spent entering identifying information in the process records. Operator errors are difficult to track and parts are sometimes misidentified. Also if there is a defective diaphragm or group of diaphragms, a recall may become necessary.

Up to this time, because markings on the diaphragms have been limited to the year and month of manufacture, the diaphragm manufacturer may need to recall several batches in the absence of a clear association between the defective items and their corresponding data sheets, since there is an absence of batch specific information on the diaphragms themselves. The present marking system is intended to alleviate these shortcomings and provide this batch specific identification directly on the diaphragms or other molded process components so that, simply by looking at the part, the operator or process engineer may know the exact provenance of the part without the aid of paperwork

### SUMMARY OF THE INVENTION

Other diaphragms besides valve diaphragms used in the food, dairy, and pharmaceutical industries could be similarly marked, for example pump diaphragms. Other seals and elastomeric valves and/or their components could also be similarly marked. Molded components used in other industries may also benefit from this marking method. Although not limited to this, this invention specifically relates to incorporation of a molded-in indexable feature (herein shown as a dial) that designates the batch number on the part itself as used in sanitary valves and other molded components for the food, dairy and pharmaceutical industries. It alternatively may consist of a stamped-in batch index code that allows batch identification in diaphragm and other food, dairy, and pharmaceutical components made of materials that are able to retain such stamped impressions.

### BRIEF DESCRIPTION OF THE DRAWINGS

FIG. 1 is an exploded view of a valve assembly including a first diaphragm;

FIG. 2 is a sectional view of a valve body with a second diaphragm mounted thereon;

FIG. 3 is a planar view of the diaphragm of FIG. 2 bearing traceable indicia;

FIG. 4 is a fragmentary view of the diaphragm of FIG. 1 with one surface bearing traceable indicia; and

FIG. 5 is a fragmentary view of the diaphragm of FIG. 1 with an opposite surface bearing traceable indicia.

### DETAILED DESCRIPTION OF EXEMPLARY EMBODIMENTS OF THE INVENTION

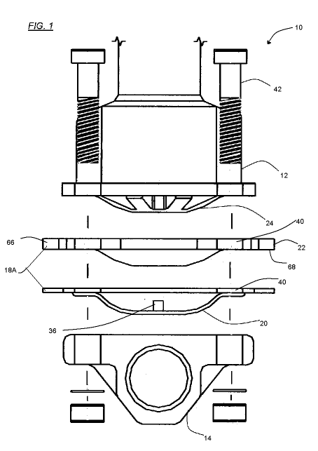

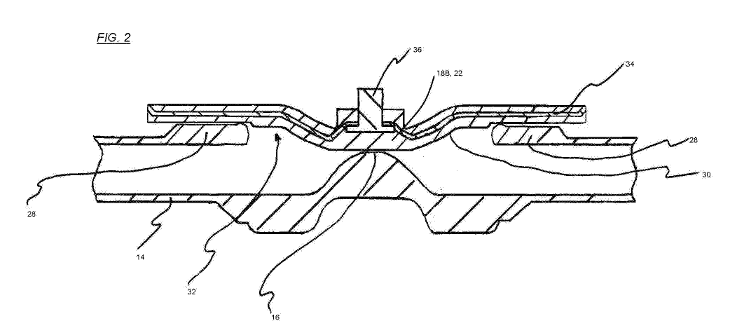

As illustrated in FIGS. 1 and 2, a valve assembly, generally designated 10, typically includes a bonnet 12, which contains the mechanical means of opening and closing the valve, and a body 14, which is formed with a seat 16 (FIG. 2) relative to which a diaphragm 18A or 18B moves to control the flow of a process stream though the valve assembly 10. The diaphragm 18A shown in FIG. 1 is formed with a non-elastomeric facing piece or weir 20 that contacts the process stream and with an elastomeric backing member 22 that distributes a closing force exerted by a compressor 24 against the weir 20.

As illustrated in FIG. 2, the diaphragm 18B may be formed, as by vacuum or blow molding, to a configuration that operatively conforms to a diaphragm-receiving area or land 28 of the valve body 14. A process-facing surface 30 of the diaphragm 18B spans a diaphragm-receiving opening 32 in the valve body 14 and extends in overlying relation to the land 28 surrounding the opening 32. The diaphragm 18B and the elastomeric backing member 22 (FIG. 1) may be molded from material such as EPDM, and provided with an intermediate reinforcing layer 34 of thermotropic liquid crystalline polymer such as Kevlar or Vectran. The weir 20 (FIG. 1) on the two-piece diaphragm 18A may be formed from polytetrafluoroethylene. A connector 36, such as a stud or threaded socket, may be molded into a central area of the diaphragm 18B or weir 20 and attached to the compressor 24 (FIG. 1) that moves the diaphragm 18B towards and away from the valve seat 16.

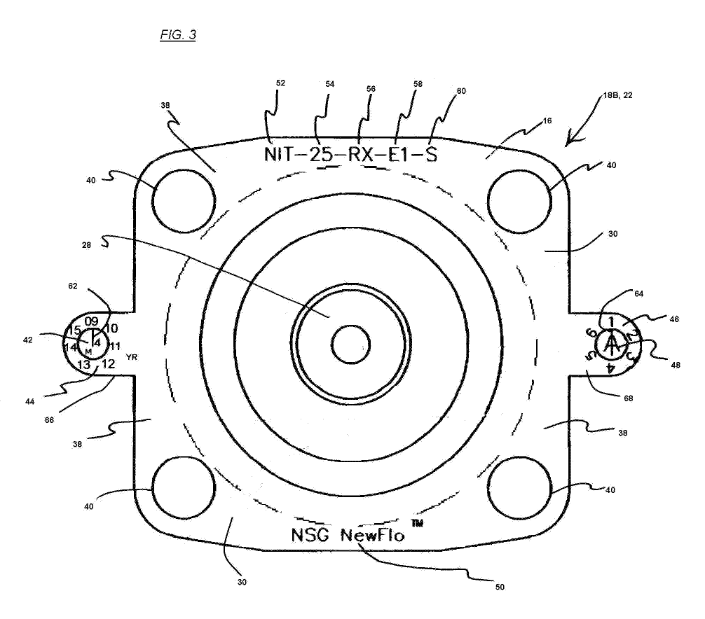

As illustrated in FIGS. 1 and 3, each of the diaphragms 18A,18B is provided with a radially outwardly disposed anchoring area 38. The anchoring area 38 may be provided with bores 40 through which connectors 42 (FIG. 1) may extend to draw the valve bonnet 12 and body 14 together, the diaphragm 18A or 18B being sandwiched therebetween. As illustrated in FIG. 3, a surface, such as the process-facing surface 30 in anchoring area 38 may be provided with traceable indicia 42-60, such as month 42 and year 44 of manufacture, batch number 46, manufacturer code 48, trade designations 50, and a part number (comprising a style code 52, a size code 54, a grade code 56, a composition code 58, and/or a construction code 60). The indicia 42-60 may be molded or stamped into the surface 30. A pointer 62 may be provided adjacent to the month 42 to indicate one of a group of years 44 surrounding the month area. Likewise, another pointer 64 may be provided adjacent to the manufacturer code letter 48 to indicate one of the surrounding batch numbers 46. The circular areas in which the pointers 62, 64 are located may be rotatable within the molding or stamping apparatus (not shown) so that the desired year 44 and batch number 46 may be indicated. Advantageously, the manufacturer 48, batch 46, year 44 and month 42 of manufacture may be provided on tabs 66, 68 extending beyond the outer edges of the valve bonnet 12 and body 14 so that they can be read when the valve 10 is assembled.

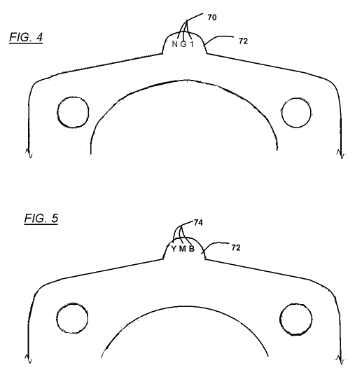

FIGS. 4 and 5 illustrate a marking system that could be employed in a part molded from a non-elastomeric material, provided it is capable of retaining the impression of a stamp. As illustrated in FIG. 4, manufacturer/material information 70 where, for example, ‘N’ is the first initial of the manufacturer and ‘G1’ is a material designation, may be encoded on one surface of an outwardly extending tab 72. As illustrated in FIG. 5, batch specific information 74, where, for example, ‘Y” is the year, ‘M’ is the month and ‘B’ is the batch number may be stamped on the opposite surface of the tab 70. In this manner, the foregoing information is readable when the valve is fully assembled with the diaphragm in place. This system is useful when marking the molded part inside the confines of the processing area of the valve might interfere with the performance and sealing properties of the diaphragm or other process component.

1. In a molded flow control component, that improvement which comprises,
a) An indicium of one or more of a group comprising manufacturer, year of production, month of production, batch number, composition, size, and regulatory compliance; and
b) said indicium being outwardly visible on the flow control component.

2. The molded flow control component according to claim 1, wherein said component is a diaphragm for a valve, said diaphragm having an elastomeric portion and wherein the indicium is molded into a tab extending from said elastomeric portion.

3. The molded flow control component according to claim 2, wherein the indicium comprises a selectively positionable pointer and a plurality of symbols disposed circumferentially to said pointer.

4. The molded flow control component of claim 1, wherein said component is a diaphragm for a valve, said diaphragm having a non-elastomeric weir and wherein the indicium is stamped into a tab extending from said weir.

5. The molded flow control component of claim 4 wherein a first indicium is stamped into one surface of the tab and a second indicium is tamped into an opposing surface of the tab.
